(19) United States
(12) Patent Application Publication
(10) Pub. No.: US 2006/0273124 A1
(43) Pub. Date: Dec. 7, 2006

(54) SLOTTTED WHEEL SUPPORT MOUNTABLE ON A LOAD CARRIER

(75) Inventor: Kevin Bogoslofski, Southington, CT (US)

Correspondence Address: NOVAK DRUCE & QUIGG, LLP, 1300 EYE STREET NW, 400 EAST TOWER, WASHINGTON, DC, 20005, US

(73) Assignee: THULE SWEDEN AB, Hillerstorp (SE)

(21) Appl. No.: 11/306,850

(22) Filed: Jan. 12, 2006

Related U.S. Application Data
(63) Continuation of application No. 11/159,131, filed on Jun. 23, 2005.
(60) Provisional application No. 60/522,056, filed on Aug. 7, 2004.
(60) Provisional application No. 60/582,383, filed on Jun. 23, 2004.

(51) Int. Cl. B62J 11/00

(52) U.S. Cl. 224/441

(57) ABSTRACT

A method and arrangement for securing a wheel to a load bar of a load carrier attached to a carrying vehicle includes a mounting assembly secured to a load bar of the load carrier. A wheel support assembly is pivotally connected to the mounting assembly such that the wheel assembly can be raised and lowered as needed. The wheel support assembly includes a pair of support bars configured for receiving a wheel therebetween. The support bars maintain a substantial parallel relationship with respect to one another and each includes an angled slot for receiving opposite ends of an axle of a wheel therein. Pivoting of the wheel assembly may be arrested by means of a gripping assembly.

### CROSS-REFERENCE TO RELATED APPLICATIONS

The present application is a continuation application of U.S. Application No. Ser. No. 11/159,131 filed Jun. 23, 2005 which claims the benefit of U.S. Provisional Application Nos. 60/522,056 filed Aug. 7, 2004 and 60/582,383 filed June 23, 2004. Said applications are expressly incorporated herein by reference in their entireties.

### TECHNICAL FIELD

The present invention relates generally to an apparatus for securing articles to a vehicle load carrier, and more specifically, to an apparatus for retaining bicycle components, to vehicle load carriers.

### BACKGROUND OF THE INVENTION

Vehicle mounted sports equipment racks are known for carrying equipment such as bicycles, skis, surfboards, canoes, kayaks, etc., and their associated equipment. Suitable vehicle mounting points for sports equipment racks typically include the rearward side or the roof of a vehicle.

For sports such as bicycling, there can be need to transport more than one bicycle, or bicycle components such as extra wheels. Rack structures that support bicycles and their related components are available and known devices have assemblies for securing entire bicycles, bicycle frames or wheels to the load bars of roof racks.

Wheel supports for securing a single wheel upon a roof rack are known and may be referred to as wheel supports or wheel forks. Known devices of this type typically have U-shaped brackets having a base in the form of a U attached to a load bar of a load carrier with the two arms of the U-shaped assembly extending vertically above the load carrier. The terminal ends of the two arms, opposite the attached base of the U, each typically include straight shallow slots for receiving an end of an axle of a bicycle wheel. Typically, after disposing the ends of a wheel axle in the shallow slots, the wheel is then secured upon the wheel holder by tightening the wheel nuts or quick release axle clamps. However, due to vibration during operation of a vehicle, it is possible for the wheel nuts or axle clamps to gradually release, which can cause the wheel to become loose from its support during transport. A loose wheel may not only result loss or damage to the wheel or transporting vehicle, but can present a serious safety hazard as the wheel may become separated from the roof rack during transport.

In view of the above, there is a need to address these and other deficiencies of known devices.

### SUMMARY OF THE INVENTION

The present invention provides an apparatus, also referred to as a sports equipment rack, for securely attaching a wheel, such as a spare bicycle wheel, to a vehicle-top load carrier As described herein, the present invention addresses the deficiencies as described above with respect to known wheel supports.

An apparatus according to the present invention is configured to securely fasten a wheel to a vehicle sports equipment rack. The apparatus broadly includes a mounting plate for a wheel support that is generally U-shaped. The mounting plate includes a hinged portion. First and second elongate support bars extend parallelly outward from the hinged portion and provide serve as supports for a wheel. The terminal ends of the wheel support bars, opposite the hinged portion, comprise slots for receiving the ends of an axle of a wheel therein. Each slot is angled and is preferably sized to be slightly greater than the axle diameter of a wheel that will be mounted in the wheel support for transporting. When not in use, the wheel support may be rotated about the hinged portion for substantially flat storage proximate the roof of the vehicle. In preparation for loading a wheel, rotation of the wheel support about the hinge portion can place it at a desired orientation, which is typically close to vertical. The wheel support includes a gripper assembly, which applies a frictional force to set and maintain the required angle and restrict rotational movement of the wheel support.

One benefit and distinguishing feature of the present invention when compared to existing wheel supports is that the angled slot effectively retains a wheel even if the axle clamps or wheel nuts are released inadvertently. An angled slot according to the present invention impedes movement of the wheel axle in the slot to thereby reduce the incidence of separation of a wheel from the roof rack during transportation.

More particularly, the present invention provides an article for securing an object to a load carrier attached to a vehicle. The article comprises (includes, but is not limited to) at least a first support bar having a side surface, a proximate end and a distal end having a first angled slot formed therein to open to the side surface, the angled slot is configured to receive the object therein to secure the object to the load carrier.

The present invention includes an apparatus for securing a wheel to a vehicle load carrier having a load bar. The apparatus includes a mounting plate held against the load carrier. A wheel support is coupled to the mounting plate by a pivoting connection that includes a shaft. The wheel support comprises a first support bar having a side surface, a proximate end and a distal end having a first angled slot formed therein open to the side surface, the angled slot is dimensioned for mounting the wheel to the load carrier. The wheel support further includes a second support bar substantially parallel to the first support bar. The second support bar has a side surface, a proximate end and a distal end having a second angled slot formed therein open to the side surface, the second angled slot is dimensioned in common with the first angled slot. Also, the wheel support comprises a sleeve including an open channel, a first end joined to the proximate end of the first support bar, and a second end joined to the proximate end of the second support bar. The shaft of the pivoting connection, received in the open channel of the sleeve, provides the pivoting connection to allow rotation of the wheel support relative to the mounting plate. The wheel support includes a gripper to interact with the pivoting connection to restrict rotation of the wheel support so that the wheel support extends outwardly of the surface of the vehicle for inserting axle ends of the wheel into the first angled slot and the second angled slot to suspend the wheel between the first support bar and the second support bar.

A method for securing a wheel to a load carrier having a load bar attached to the surface of a vehicle comprises providing an apparatus including a mounting plate held against the load carrier and having a wheel support coupled to the mounting plate by a pivoting connection. The apparatus includes a wheel support comprising a first support bar having a side surface, a proximate end and a distal end having a first angled slot formed therein open to the side surface. The angled slot is dimensioned for mounting the wheel to the load carrier. A second support bar, substantially parallel to the first support bar, has a side surface, a proximate end and a distal end having a second angled slot formed therein open to the side surface, the second angled slot is dimensioned in common with the first angled slot. The wheel support also includes a sleeve having an open channel, a first end joined to the proximate end of the first support bar, and a second end joined to the proximate end of the second support bar. The shaft of the pivoting connection is received in the open channel thereby allowing rotation of the wheel support relative to the mounting plate. Activating a gripper interacting with the pivoting connection restricts rotation of the wheel support so that the wheel support extends outwardly of the surface of the vehicle. Inserting axle ends of a wheel into the first angled slot and the second angled slot suspends the wheel between the first support bar and the second support bar. Tightening axle clamps secures the wheel to the wheel support and to the load carrier.

### DESCRIPTION OF DRAWINGS

The invention will now be described in greater detail in the following, by way of example only and with reference to the attached drawings, in which:

FIG. 1 is a side elevational view showing a support according to the present invention for retaining a wheel upon a vehicle load carrier;

FIG. 2 is a perspective view of a wheel support according to the present invention;

FIG. 3 is a side elevational view of a wheel support according to the present invention, which illustrates the wheel support in a substantially lowered position;

FIG. 4 is a side elevational view of a wheel support according to the present invention, which illustrates the wheel support in a substantially raised position; and

FIG. 5 is a side elevational view showing use of wheel support slots to receive the axle of a wheel to secure a wheel to a vehicle load carrier.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention.

Referring to the figures, wherein like numbers refer to like parts throughout the several views, FIG. 1 is a side elevational view illustrating wheel 10 secured to roof mounted apparatus 12, also referred to herein as a sports equipment rack, attached to vehicle 14.

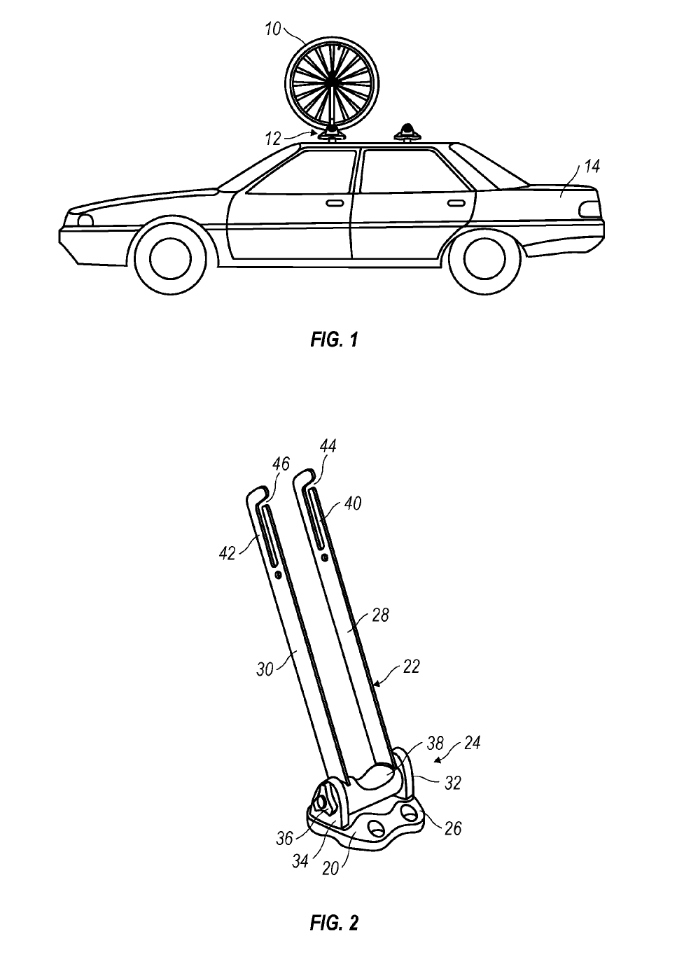

FIG. 2 illustrates an assembly according to the present invention for securely fastening of wheel 10 to sports equipment rack 12 of vehicle 14. The assembly includes mounting plate 20 and wheel support 22 that has pivoting connection 24 to mounting plate 20.

Wheel support 22 according to the present invention is a generally U-shaped structure and included sleeve 26, having first support bar 28 attached to one end, and second support bar 30 attached to the other. First support bar 28 and second support bar 30 extend outwardly of sleeve 26 and maintain substantial parallel relationship to each other.

Sleeve 26 is configured to rotate about a shaft (not shown) secured between projections 32, 34. Projections 32, 34 are secured to mounting plate 20 so that the support bars 28, 30 may pivot about the mounting plate 20. This configuration provides a hinged connection between wheel support 22 and mounting plate 20. Gripper 36 abuts the outside surface of one of projections 32, 34 and has a threaded connection to an end of the shaft. Rotation of gripper 36 tightens sleeve 26 between projections 32, 34 to thereby restrict movement of sleeve 26, which arrests rotational movement of wheel support 22 with respect to mounting plate 20. Pad 38, attached to the outside of sleeve 26 between support bars 28, 30 provides a layer of frictional material to cushion the surface of the tire of a bicycle wheel inserted in wheel support 22. When the surface of the tire contacts friction pad 38, wheel 10 becomes substantially immobilized and does not rotate about its axle during transport.

The ends of support bars 28, 30, opposite the ends connected to sleeve 26, each have an angled slot formed therein. First angled slot 40, formed at the end of first support bar 28, is substantially identical to second angled slot 42, formed at the end of second support bar 30. As shown in FIG. 2, angled slots 40, 42 each open to identical sides of support bars 28, 30 to provide first entry 44 of first angled slot 40 and second entry 46 of second angled slot 42. It should be appreciated that the slots 40, 42 are referred to as angled because they are usually offset from horizontal and vertical when in a use position such as shown in FIG. 2, but they may be oriented parallel to a longitudinal axis of the containing support bar which is exemplified in the several figures.

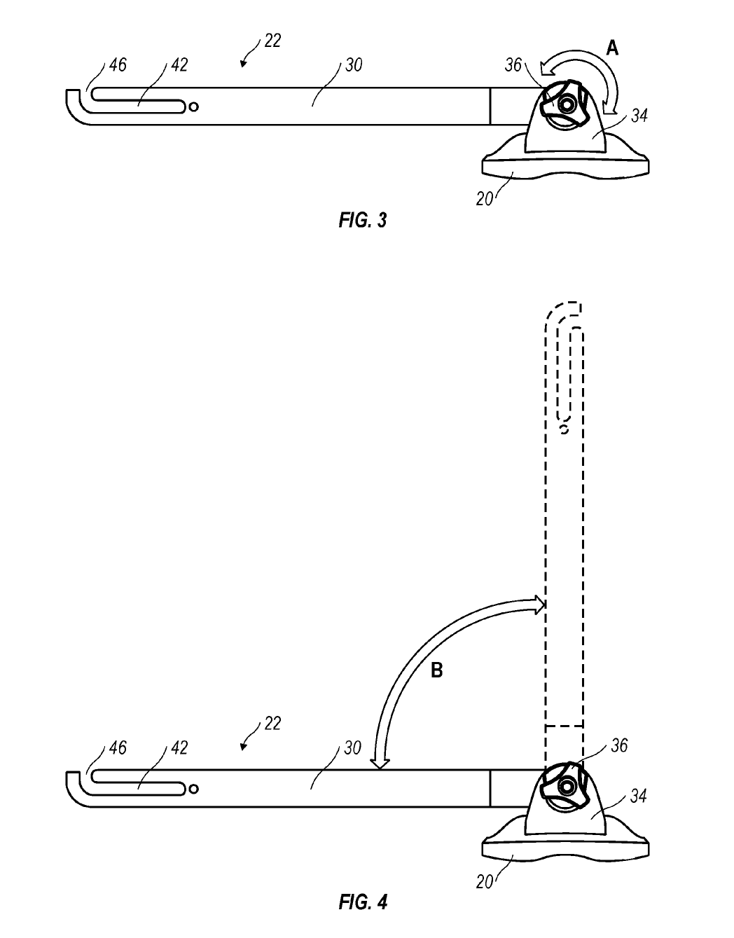

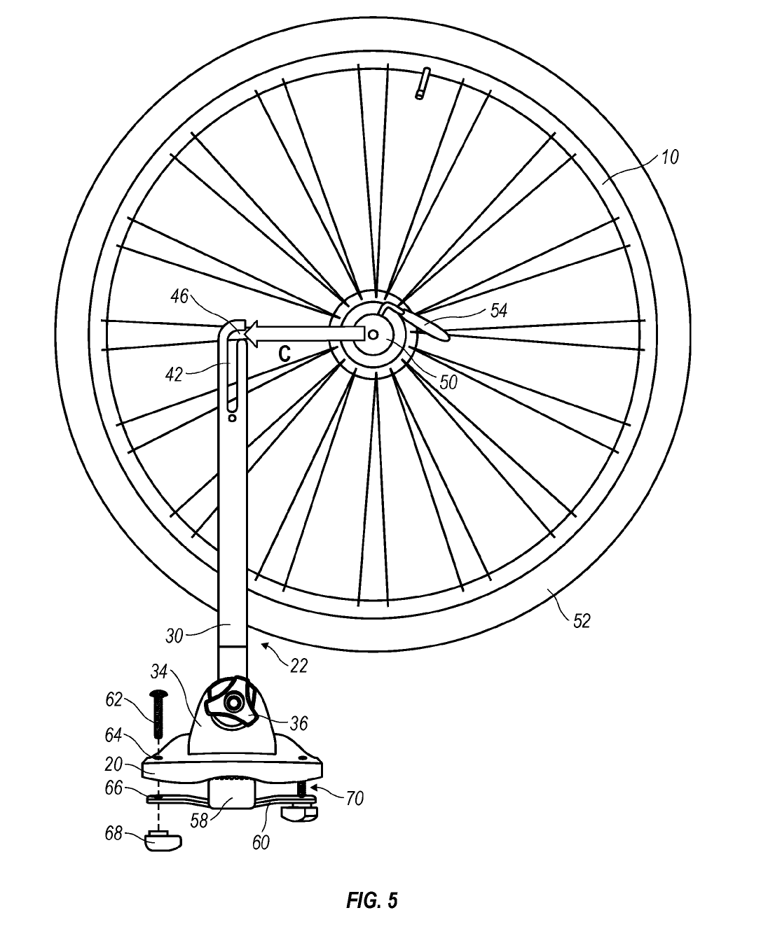

FIGS. 3 and 4 illustrate rotation of wheel support 22 relative to mounting plate 20. As indicated above, gripper 36 may be rotated towards projection 34, as indicated by arrow A, to tighten or relax pivoting connection 24 to set wheel support 22 at a desired angle. Pivoting connection 24 conveniently allows wheel support 22 to be disposed towards the roof of carrying vehicle 14, when not in use, and disposed above the roof of vehicle 14, and substantially perpendicular therewith, when needed.

FIG. 4 illustrates rotational movement of wheel support 22, from the substantially horizontal position shown in FIG. 3, to the substantially vertically position illustrated in phantom in FIG. 4, along the path referenced by arrow B. To vertically position wheel support 22 as illustrated in FIG. 4, gripper 36 is actuated to release pivoting connection 24, for example by turning gripper 36 in a counter-clockwise direction. Thereafter, after wheel support 22 has been rotated to a substantially vertical position, gripper 36 may be turned in an opposite, clockwise direction, to retain wheel support 22 in its vertical position.

FIG. 5 is a side elevational view illustrating positioning of wheel 10 between support bars 28, 30 of wheel support 22 so that opposite ends of wheel axle 50 may be aligned with entry portions 44, 46 of first angled slot 40 and second angled slot 42 formed in first support bar 28 and second support bar 30, respectively. A method of attaching wheel 10 to wheel support 22 includes inserting wheel 10 between support bars 28, 30, in the direction of arrow C until opposing ends of wheel axle 50 each engage and reside in one of entries 44, 46 of angled slots 40, 42. Further movement of the axle ends in the direction of angled slots 40, 42 causes wheel 10 to drop downward as the axle ends follow the straight portion of each slot 40, 42. Wheel 10 is, thus, caused to drop down into slots 40, 42 until tire 52 rests upon friction pad 38, attached to sleeve portion 26 of wheel support 22. The slots 40, 42 have a length which allows wheels of different sizes to be accommodated by the wheel support 22. With tire 52 seated against friction pad 38, axle clamps 54 may be actuated to secure wheel 10 in slots 40, 42. The friction pad 38 acts to prevent the wheel 10 from rotating by providing a friction surface in contact with the tire 52. As noted above, the adjustment of the slots 40, 42 act in conjunction with the friction pad 38 to accommodate wheels and tires of different dimensions.

The use of angled slots 40, 42 effectively retains wheel 10 within wheel support even in the event axle clamps 54 inadvertently release. Comparison with conventional wheel supports reveals that angled slots 40, 42 according to the present invention are longer and are more capable of retaining wheels 10 within wheel supports. Additionally, angled entries 44, 46 which are hooked at the ends of support bars 28, 30, tend to impede the movement of axle 50 as it approaches the open end of angled slots 40, 42. Consequently, it is believed that the use of longer slots 40, 42 combined with angled entries 44, 46, substantially reduce the possibility of wheel 10 separation during transport.

It is preferred, during transportation of sports cycles and related equipment, to protect the cycles and a vehicle from damage, such as dents and scratches. For this reason, materials selected to fabricate an apparatus according to the present invention include those having structural rigidity to support secured items combined with cushioning characteristics that will reduce the possibility of appearance marring damage. Suitable materials include metals and relatively rigid rubbers and plastics. As needed, these materials may be provided with softer covers for added protection over components that could have sharp projections.

FIG. 5 illustrates clamp 60 securing mounting plate 20 to load bar 58 of an apparatus such as a sports equipment rack. Load bar 58 is secured between mounting plate 20 and clamp 60 by inserting fasteners, e.g., bolts 62 through each of several throughbores 64 in mounting plate 20 and through openings 66 at each end of clamp 60. The application of nut 68 to each of bolts 62 passing through opposing openings 66 in each clamp 60 provides connection assembly 70 connecting clamp 60 to mounting plate 20. Tightening nuts 68 to bolts 62 increases the gripping force between each clamp 60 and mounting plate 20 to firmly attach wheel support 22 to load bar 58. Preferably, mounting plate 20 includes four holes 64 requiring two clamps 60 and two connection assemblies 70 for firm attachment to load bar 58. Connection assemblies 70 according to the present invention may be used to attach wheel supports 22 to load bars that may vary in cross sectional appearance, e.g., load bars comprising arcuate, circular and oval cross sections, etc., or combinations thereof.

A wheel support according to the present invention and an apparatus securing wheels to a load carrier of a transporting vehicle and related components have been described herein. These and other variations, which will be appreciated by those skilled in the art, are within the intended scope of this invention as claimed below. As previously stated, detailed embodiments of the present invention are disclosed herein; however, it is to be understood that the disclosed embodiments are merely exemplary of the invention that may be embodied in various forms.

What is claimed is:

1. A device used to secure an object to a load carrier attached to the surface of a vehicle, the article comprising:
a first support bar having a first side surface and a first proximate end and a first distal end, the first distal end having a first angled slot formed therein and being open at the first side surface of the first support bar for permitting insertion of a first object into the first angled slot that is to be secured to the load carrier, the first angled slot having dimensions suitable for receiving the first object with a minimum clearance between the first object and interior surfaces of the first angled slot.

2. The device as recited in claim 1, further comprising a second support bar oriented substantially parallel to the first support bar, the second support bar having a second side surface and a second proximate end and a second distal end, the second distal end having a second angled slot formed therein and being open at the second side surface of the second support bar for permitting insertion of a second object into the second angled slot that is to be secured to the load carrier, the second angled slot having dimensions suitable for receiving the second object with a minimum clearance between the second object and interior surfaces of the second angled slot.

3. The device as recited in claim 2, wherein the first support bar and the second support bar are interconnected by a sleeve having a first sleeve end joined to the first proximate end of the first support bar and a second sleeve end joined to the second proximate end of the second support bar.

4. The device of claim 3, further comprising a mounting plate coupled to the sleeve by a pivot connection and thereby accommodating rotation of the sleeve relative to the mounting plate.

5. The device of claim 4, wherein the mounting plate includes a plurality of open channels extending through the mounting plate to receive bolts of connecting assemblies used to attach the wheel support to the load carrier.

6. The device of claim 5, wherein the connecting assemblies comprise an elongate clamp having a threaded opening at opposing ends for engaging bolts inserted into the open channels of the mounting plate.

7. The device of claim 4, further including a gripper interacting with the pivot connection to restrict rotation of the sleeve relative to the mounting plate.

8. The device of claim 4, wherein the first support bar, the second support bar and the interconnecting sleeve form a wheel support for a bicycle above the mounting plate so that the wheel support extends outwardly from the surface of the vehicle and positions the first and second angled slots for insertible reception of ends of a wheel axle of a bicycle to be suspended upon the wheel support between the first support bar and the second support bar.

9. The device of claim 2, wherein each of the first and second angled slots have an entrance thereto formed by an arcuate entry portion terminating in a straight portion of the respective slot.

10. The device of claim 9, wherein the straight portion of each of the first and second angled slots is axial aligned with a longitudinal axis of the containing support bar.

11. The device as recited in claim 8, wherein the wheel support further comprises a friction pad arranged to arrest spin of a bicycle wheel suspended upon the wheel support.

11. The device as recited in claim 8, wherein each of the first and second angled slots are elongate and thereby accommodate the suspension of different size wheels on the same wheel support.

13. An apparatus for securing a wheel to a load bar of a load carrier attached to a vehicle, the apparatus comprising:
a mounting plate held against the load carrier;
a pivoting connection having a shaft rigidly attached to the mounting plate; and
a wheel support comprising a first support bar having a side surface, a proximate end and a distal end having a first angled slot formed therein open to the side surface, the angled slot having dimensions for mounting the wheel to the load carrier;
a second support bar substantially parallel to the first support bar, the second support bar having a side surface, a proximate end and a distal end having a second angled slot formed therein to open to the side surface, the second angled slot having dimensions in common with the first angled slot; and
a sleeve having an open channel, a first end joined to the proximate end of the first support bar, and a second end joined to the proximate end of the second support bar, the shaft received in the open channel providing the pivoting connection to allow rotation of the wheel support relative to the mounting plate.

14. The apparatus of claim 11, wherein the mounting plate includes a plurality of open channels, extending through the mounting plate to receive bolts of connecting assemblies used to attach the apparatus to the load carrier.

15. The apparatus of claim 12, wherein the connecting assemblies comprise an elongate clamp having a threaded opening at opposing ends for engaging the bolts inserted into open channels of the mounting plate.

16. The apparatus of claim 11, further including a gripper interacting with the pivoting connection to restrict rotation of the wheel support.

17. The apparatus of claim 11, wherein the first angled slot and the second elongate slot each include an open ended arcuate entry portion and a straight portion.

18. The apparatus of claim 15, wherein there is axial alignment of the straight portion of the first slot with the longitudinal axis of the first support bar and axial alignment of the straight portion of the second slot with the longitudinal axis of the second support bar.

19. The apparatus of claim 11, wherein said first angled slot and second angled slot accommodate wheels of different sizes.

20. The apparatus of claim 11, wherein a friction pad is mounted on said sleeve.

21. An apparatus for securing a wheel to a load carrier having a load bar attached to the surface of a vehicle, the apparatus comprising:
a mounting plate attached to a load carrier;
a wheel support, coupled to the mounting plate by a pivoting connection having a shaft rigidly attached to the mounting plate, the wheel support comprising a first support bar having a side surface, a proximate end and a distal end having a first angled slot formed therein to open to the side surface, the angled slot having dimensions for mounting the wheel to the load carrier;
a second support bar substantially parallel to the first support bar, the second support bar having a side surface, a proximate end and a distal end having a second angled slot formed therein to open to the side surface, the second angled slot having dimensions in common with the first angled slot;
a sleeve including an open channel, a first end joined to the proximate end of the first support bar, and a second end joined to the proximate end of the second support bar, the shaft received in the open channel providing the pivoting connection to allow rotation of the wheel support relative to the mounting plate; and
a gripper that interacts with the pivoting connection to restrict rotation of the wheel support so that the wheel support extends outwardly of the surface of the vehicle for inserting ends of the wheel's axle into the first angled slot and the second angled slot to suspend the wheel between the first support bar and the second support bar.

22. A method for securing a wheel to a load carrier having a load bar attached to the surface of a vehicle, the method comprising:
providing an apparatus including a mounting plate held against the load carrier and having wheel support, coupled to the mounting plate by a pivoting connection, the wheel support comprising a first support bar having a side surface, a proximate end and a distal end having a first angled slot formed therein to open to the side surface, the angled slot having dimensions for mounting the wheel to the load carrier;
a second support bar substantially parallel to the first support bar, the second support bar having a side surface, a proximate end and a distal end having a second angled slot formed therein to open to the side surface, the second angled slot having dimensions in common with the first angled slot; and
a sleeve having an open channel, a first end joined to the proximate end of the first support bar, and a second end joined to the proximate end of the second support bar, the shaft received in the open channel providing the pivoting connection to allow rotation of the wheel support relative to the mounting plate
activating a gripper that interacts with the pivoting connection to restrict rotation of the wheel support so that the wheel support extends outwardly of the surface of the vehicle;
inserting ends of the wheel axle into the first angled slot and the second angled slot to suspend the wheel between the first support bar and the second support bar; and
tightening wheel axle clamps to secure the wheel to the wheel support.

23. The method of claim 18, wherein the mounting plate includes a plurality of open channels, extending through the mounting plate to receive bolts of connecting assemblies used to attach the wheel support to the load carrier.

24. The method of claim 19, wherein the connecting assemblies comprise an elongate clamp having a threaded opening at opposing ends for engaging bolts inserted into the open channels of the mounting plate.

25. An assembly for securing a wheel to a vehicle load carrier comprising at least one load bar, said assembly comprising:
a mounting assembly securable to said at least one load bar; and,
a wheel supporting assembly, said wheel supporting assembly connected to said mounting assembly and configured for adjustable, lockable pivotal movement with respect thereto, said wheel support assembly including a pair members for receiving opposite sides of a wheel.

26. The assembly as recited in claim 21 wherein said wheel support assembly comprises a pair of support bars substantially parallel with one another and arranged to receive a portion of a wheel therebetween.

27. The assembly as recited in claim 22 wherein each said support bar comprises a slot for receiving an opposite end of an axle portion of said wheel.

28. The assembly as recited in claim 23 wherein each said slot is of sufficient length to cause a perimeter of said wheel to abut a surface of said mounting assembly.

29. The assembly as recited in claim 24 wherein each said slot assembly comprises an axle entry portion and an axle retaining portion.

30. The assembly as recited in claim 25 wherein said axle entry portion and said axle retaining portion are disposed at different angles with respect to one another.

31. The assembly as recited in claim 26 wherein said axle entry portion and said axle retaining portion are substantially perpendicularly disposed with respect to one another.

32. The assembly as recited in claim 21 wherein said pivotal movement of said wheel supporting assembly is arrested by means of a rotatable gripping assembly.
